(19) United States
(12) Patent Application Publication
(10) Pub. No.: US 2006/0112014 A1
(43) Pub. Date: May 25, 2006

(54) Bar-coded business card information capture and retrieval

(76) Inventor: Mohammed Abdul Hameed Abdul Azeem, Shuwaikh Port (KW)

Correspondence Address: ABELMAN, FRAYNE & SCHWAB, 666 THIRD AVENUE, 10TH FLOOR, NEW YORK, NY, 10017, US

(21) Appl. No.: 10/998,021

(22) Filed: Nov. 24, 2004

(51) Int. Cl. G06F 17/60

(52) U.S. Cl. 705/50

(57) ABSTRACT

A system and method store all the information, such as the name, title, telephone number, fax number, e-mail address, and the like, on the business card itself using a barcode, as opposed to an identification number of the card. The system and method do not require any link to any server or to the Internet to receive the information. The contact information is input to a stand-alone computer in a format that can be imported into bar code encoding software loaded on the computer without the need of keying the data in or retrieving it from a server.

### FIELD OF THE INVENTION

This invention relates to business cards, and in particular to a computerized system and method for capturing and retrieving information encoded as bar codes on business cards.

### BACKGROUND OF THE INVENTION

Thousands of business cards are exchanged daily between businessmen. Although many of such exchanged business cards are filed away and cataloged for later reference, many are also simply discarded or stored, for example, in drawers or boxes or left on the table of a meeting, and so are rarely, if ever, retrieved thereafter. Retrieving a card is usually difficult and time-consuming unless the cards are properly organized and indexed.

One solution is to key in the data from the business card into contact management software on a computer or a PDA. However, this process is time-consuming and laborious, especially if the number of cards is large.

Another solution is to implement bar codes on the business cards, with the bar codes capable of being read by a computer. One proposed solution is described in U.S. application publication number 2003/0226886 to Kakinuma, filed Dec. 19, 2002, and entitled BUSINESS CARD INFORMATION MANAGEMENT SYSTEM, which is incorporated herein by reference in its entirety.

However, the Kakinuma publication describes a system which prints on the business card a bar coded index or a pointer to the information that had been previously entered and stored on a central computer, such as a database server or a server on a local LAN, or on the Internet.

Such a system requires a subscription to the database server to store and retrieve the information on the business card. The barcode used in this prior art system encodes card index data to be used to identify the card in a card index, and not to encode personal contact information about the business card holder, which is stored separately on the server. The system also requires a telecommunications link, such as a LAN, a WAN, or the Internet, to the server in order to operate.

I have invented a bar code scanning system and method that stores contact information on the card instead of card index identification information. I have also invented a bar code scanning system and method which does not need a database server or a telecommunication link to the server to operate.

### BRIEF SUMMARY OF THE INVENTION

The present invention is directed to a system and method which store all the information, such as the individual's name, and business affiliation or organization, title, telephone number, fax number, e-mail address, product line, and any other relevant information, on the business card itself using a barcode, as opposed to an identification number of the card. The present system does not require any link to any server or to the Internet to receive the information. The information can be input to a stand-alone computer in a format that can be imported into the bar code encoding software of the prior art without keying the data in or retrieving it from a server. As used herein, a stand-alone computer means any computer that is self-contained and that can be used independently of a network to practice the present invention.

### BRIEF DESCRIPTION OF THE DRAWINGS

Preferred embodiments of the invention are described below with reference to the drawings wherein:

FIG. 1 illustrates a block diagram of a computerized system for managing business card information in accordance with the present invention;

FIG. 2 illustrates a flowchart of the method of operation of the present invention;

FIG. 3 illustrates a front side view of a typical business card;

FIG. 4 illustrates a rear side view of the business card of FIG. 3 having a bar code in accordance with the present invention; and

FIG. 5 illustrates a list of data encoded in the bar code shown in FIG. 5.

### DETAILED DESCRIPTION OF THE INVENTION

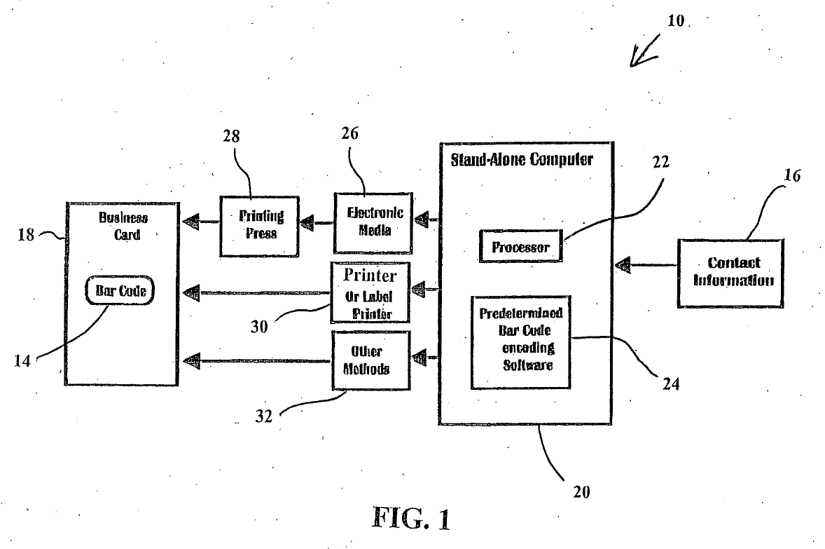

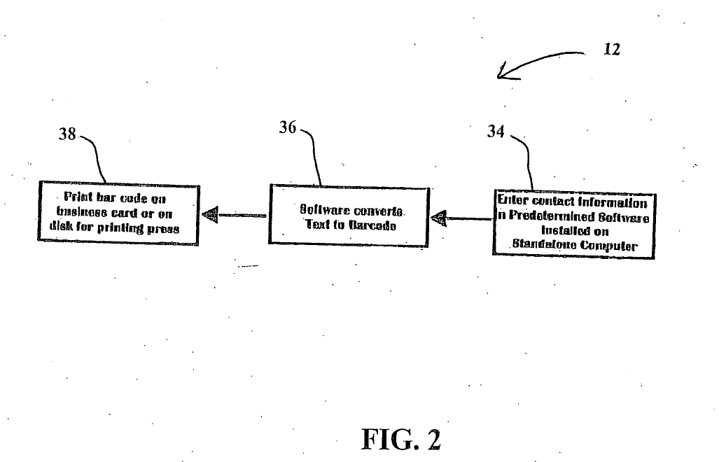

As shown in FIGS. 1-2, the present invention includes a computerized system 10 and method 12 which are capable of generating a bar code 14 encoding on a business card 18 contact information 16 inputted to a stand-alone computer 20. The stand-alone computer 20 includes a processor 22 for operating predetermined bar code encoding software. The stand-alone computer 20 includes or is connected to an input device (not shown in FIG. 1) for receiving the contact information 16 from a user or an outside source of the contact information 16. The input device may be a keyboard connected to the processor 22 of the computer 20 for entry of the contact information 16 to the computer 20. The processor 22 saves the contact information 16 in a predetermined data format for storage, business card and contact management, information retrieval, and printing of the bar code 14 on the business card 18.

During the business card design phase, the card designer obtains the information to include in the encoded format. The bar code 14 encodes the following minimum information concerning the card holder in encoded format:

1. full name,

2. title,

3. organization,

4. telephone numbers,

5. fax numbers,

6. email address, and

7. physical address.

Additional information can be stored such as a website address, shipping and mailing addresses, specific product and/or services represented, and the like. The designer uses predetermined software capable of encoding the information and generating the machine readable bar code 14 that can be printed on the card 18 by one or more printing devices described herein. To simplify encoding of the bar code 14, the encoded data corresponding to the contact information 16 can be formatted using the known vCard standard for personal data interchange.

As shown in FIG. 1, the contact information 16 is processed by the predetermined bar code encoding software 24 to be sent in an appropriate data format as electronic media 26, for example, on a disk to a printing press 28 to generate the business card 18 with the bar code 14 printed thereon, or to generate the bar code 14 on a pre-existing business card 18. Alternatively, the predetermined bar code encoding software 24 sends data signals corresponding to the contact information 16 to a printer and/or a label printer 30 to generate the business card 18 with the bar code 14 printed thereon, or to generate the bar code 14 on a pre-existing business card 18. In other embodiments, the predetermined bar code encoding software 24 sends data signals corresponding to the contact information 16 to other methods 32 or devices known in the art for generating the business card 18 with the bar code 14 printed thereon, or for generating the bar code 14 on a pre-existing business card 18. For example, the other methods 32 and devices may include laser etching devices or embossing devices for physically altering the surface of the business card 18 without printing to form a readable bar code 14 thereon.

Once printed on the business card 18, the contact information 16 can simply be scanned into a computer using a standard barcode reader such as scanners that are well known in the art.

As shown in the flowchart of FIG. 2, the present invention includes a method 12 of operation of the system 10, in which a user enters in step 24 the contact information 16 in predetermined encoding software 24 installed on the stand-alone computer 20, the encoding software 24 converts in step 36 the text of the contact information 16 to a bar code 14, and a printing device such as the printing press 28, printer or label printer 30, or other known methods 32 prints the bar code 14 on a business card 18, or the bar code 14 is saved on a disk as the electronic media 26 for use by the printing press 28 to generate the bar code 14 on the business card 18.

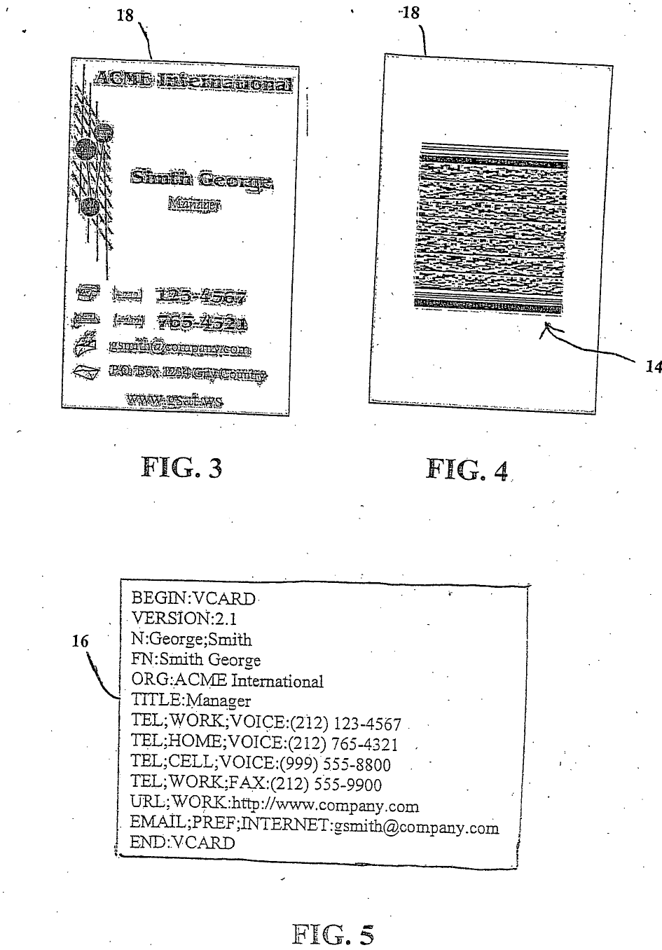

In the embodiments shown in FIGS. 3 and 4, the system 10 and method 12 create the business card 18 or bar card having a two-dimensional bar code 14 in the known PDF417 barcode standard printed on the back of the card 18. The data corresponding to the contact information 16 is provided using vCard standard format in the listing shown in FIG. 5.

Once the bar code 14 is printed on the business card 18, the bar code can be scanned with a 2D scanner and saved and processed as a *.vcf file, such that the data is ready to be imported into any known compatible contact management software with vCard import capability such as Microsoft™ Outlook™, Lotus™ Notes™, ACT™, and others. The file can also be emailed or managed with various known vCard applications.

While the preferred embodiment of the present invention has been illustrated and described herein, it is to be understood that the embodiment is provided by way of example only. Numerous variations, changes and substitutions will be apparent to those of ordinary skill in the art without departing from the invention. Accordingly, it is intended that the invention be limited only by the spirit and scope of the appended claims.

I claim:

1. A system for managing information on business cards comprising:
a stand-alone computer system for receiving contact information and including bar code encoding software for encoding a bar code; and
a bar code printer for printing the encoded bar code on a business card, wherein the bar code encodes card holder contact information including at least the name, title, organization, and communication information pertaining to the card holder.

2. The system of claim 1, wherein the business card communication information include the telephone numbers, fax numbers, an email address, and a physical address of the card holder.
